(19) United States
(12) Patent Application Publication
(10) Pub. No.: US 2016/0129489 A1
(43) Pub. Date: May 12, 2016

(54) A WIRE ROD HAVING TENSILE STRENGTH OF 950 TO 1600MPa FOR MANUFACTURING A STEEL WIRE FOR A PEARLITE STRUCTURE BOLT, A STEEL WIRE HAVING TENSILE STRENGTH OF 950 TO 1600MPa FOR A PEARLITE STRUCTURE BOLT, A PEARLITE STRUCTURE BOLT, AND MANUFACTURING METHOD FOR THE SAME

(71) Applicants: HONDA MOTOR CO., LTD., Tokyo (JP); NIPPON STEEL & SUMITOMO METAL CORPORATION, Tokyo (JP)

(72) Inventors: Makoto OKONOGI, Chiba-shi (JP); Nariyasu MUROGA, Kisarazu-shi (JP); Motoki HISHIDA, Utsunomiya-shi (JP)

(73) Assignees: NIPPON STEEL & SUMITOMO METAL CORPORATION, Tokyo (JP); HONDA MOTOR CO., LTD., Tokyo (JP)

(21) Appl. No.: 14/895,837

(22) PCT Filed: Jun. 6, 2014
(86) PCT No.: PCT/JP2014/065099

§ 371 Date: Dec. 3, 2015

(30) Foreign Application Priority Data
Jun. 13, 2013 (JP) 2013-124740

(51) Int. Cl. B21C 1/02; C22C 38/22; C22C 38/16; C22C 38/14; C22C 38/12; C22C 38/08; C22C 38/06; C22C 38/04; C22C 38/02; C22C 38/00; C21D 9/52; C21D 8/06; C21D 6/00; C21D 1/60; C21D 1/607; F16B 33/00; C22C 38/60

(52) U.S. Cl. CPC B21C 1/02; C22C 38/60; C22C 38/22; C22C 38/16; C22C 38/14; C22C 38/12; C22C 38/08; C22C 38/06; C22C 38/04; C22C 38/02; C22C 38/002; C22C 38/001; C21D 9/525; C21D 8/065; C21D 6/004; C21D 6/005; C21D 6/008; C21D 1/60; C21D 1/607; F16B 33/00

(57) ABSTRACT

A wire rod having a tensile strength of 950 to 1600 MPa for manufacturing a steel wire for a pearlite structure bolt according to the present invention includes a predetermined chemical composition and is manufactured by hot rolling and then direct isothermal transformation treating, in which when an amount of C in terms of mass % is indicated as <C>, a structure at an area from a surface of the wire rod to a depth of 4.5 mm includes 140×<C> area % or more of a pearlite structure, the average block size of a pearlite block at the area from the surface of the wire rod to the depth of 4.5 mm is 20 μm or less, in which the average block size is measured in a transverse section of the wire rod, and the average lamellar spacing of the pearlite structure at the area from the surface of the wire rod to the depth of 4.5 mm is more than 120 nm to 200 nm.

### TECHNICAL FIELD

The present invention relates to a wire rod having tensile strength of 950 to 1600 MPa and having excellent hydrogen embrittlement resistance and cold workability for manufacturing a steel wire for a pearlite structure bolt, the steel wire having tensile strength of 950 to 1600 MPa for the pearlite structure bolt, the pearlite structure bolt, and a manufacturing method for the same.

Priority is claimed on Japanese Patent Application No. 2013-124740, filed Jun. 13, 2013, the content of which is incorporated herein by reference.

### BACKGROUND ART

There is a growing need for high strength bolt for reducing vehicle weight and conserving space of vehicle. Conventionally, a high strength bolt having tensile strength of 950 MPa or more is made by forming alloy steel wire such as SCM435, SCM440, SCr440, or the like in a predetermined shape, and then, quenching, and tempering.

However, if tensile strength of the high strength bolt excesses 950 MPa, delayed fracture due to hydrogen embrittlement easily occurs, and thus, use of the high strength bolt is restricted.

A method in which structure is controlled to be a pearlite structure and the structure is strengthened by wire drawing has been known as a method for limiting the hydrogen embrittlement to improve delay fracture resistance (hydrogen embrittlement resistance) of the high strength bolt, and there have been many proposals (for example, see Patent Documents 1 to 11).

For example, Patent Document 11 discloses a high strength bolt having tensile strength of 1200 N/mm² or more, of which structure is controlled to be the pearlite structure and to which the wire drawing is performed. Patent Document 3 discloses a pearlite structure wire rod for high strength bolt having tensile strength of 1200 MPa or more.

In a high strength bolt having a pearlite structure which is strengthened by wire drawing, it is assumed that hydrogen is captured at a boundary of cementite and ferrite of the pearlite structure to limit introduction of hydrogen into steel, and thus, the hydrogen embrittlement resistance of the high strength bolt increases.

The hydrogen embrittlement resistance of the high strength bolt having tensile strength of 950 MPa or more is enhanced to a certain extent by wire drawing the pearlite structure. However, the hydrogen embrittlement resistance cannot be sufficiently enhanced by only the method, and thus, the method cannot create a radical solution. In addition, a method which can enhance both the hydrogen embrittlement resistance and the cold workability is not yet established.

### PRIOR ART DOCUMENTS

### Patent Documents

[Patent Document 1] Japanese unexamined patent application, First Publication No. S54-101743
[Patent Document 2] Japanese unexamined patent application. First Publication No. H11-315348
[Patent Document 3] Japanese unexamined patent application, First Publication No. H11-315349
[Patent Document 4] Japanese unexamined patent application, First Publication No. 2000-144306
[Patent Document 5] Japanese unexamined patent application, First Publication No. 2000-337332
[Patent Document 6] Japanese unexamined patent application, First Publication No. 2001-348618
[Patent Document 7] Japanese unexamined patent application, First Publication No. 2002-069579
[Patent Document 8] Japanese unexamined patent application, First Publication No. 2003-193183
[Patent Document 9] Japanese unexamined patent application, First Publication No. 2004-307929
[Patent Document 10] Japanese unexamined patent application, First Publication No. 2005-281860
[Patent Document 11] Japanese unexamined patent application. First Publication No. 2008-261027

### SUMMARY OF INVENTION

### Problems to be Solved by the Invention

In view of the conventional art, the problem to be solved by the present invention is to enhance the hydrogen embrittlement resistance of the high strength bolt having tensile strength of 950 to 1600 MPa, and the object of the present invention provides a pearlite structure bolt which can achieve the problem, a steel wire having excellent cold workability for the bolt, a wire rod having excellent cold workability for manufacturing the steel wire, and manufacturing method for the same. In the present invention. “high strength bolt” indicates a boll having a tensile strength of 950 to 1600 MPa.

### Method for Solving the Problem

In order to provide excellent hydrogen embrittlement resistance to the high strength bolt having a tensile strength of 950 to 1600 MPa, it is effective that surface layer structure of mechanical parts such as, for example, a bolt, is controlled to a pearlite structure in which a pearlite block is elongated in a drawing direction. The pearlite structure has a laminated constitution constructed from layer mainly consisting of cementite (hereinafter “cementite layer”) and layer mainly consisting of ferrite (hereinafter “ferrite layer”). The laminated constitution acts as resistance against introduction of hydrogen from the surface layer (hydrogen embrittlement resistance). When the pearlite block is elongated in the drawing direction, a direction of the layered constitution of the pearlite structure is made uniform, and thus, the hydrogen embrittlement resistance is further enhanced.

On the other hand, in order to enhance the cold workability of the steel wire for the high strength bolt, it is effective that the steel wire is softened to increase elongation. Generally, if an amount of C of steel increases, the cold workability of the steel deteriorates. Thus, it is necessary for obtaining good cold workability to decrease the amount of C to 0.65 mass % or less. However, if the amount of C decreases, dual phase structure constructed from pro-eutectoid ferrite and pearlite easily forms. Especially, in the surface layer of the wire rod, the amount of C is further decreased by decarburization and the pro-eutectoid ferrite easily forms. In addition, in the surface layer of the wire rod, bainite structure easily forms, since cooling rate therein is high.

Hydrogen embrittlement resistance of the dual phase structure constructed from the pro-eutectoid ferrite and the pearlite, and hydrogen embrittlement resistance of the bainite are especially lower than hydrogen embrittlement resistance of the pearlite. If the amount of C is decreased, the dual phase structure constructed from the pro-eutectoid ferrite and the pearlite, and the bainite easily form, and thus, the hydrogen embrittlement resistance of surface part of mechanical parts such as, for example, a bolt, deteriorates. In addition, if the dual phase structure constructed from the pro-eutectoid ferrite and the pearlite, and the bainite form, the strength of the surface part becomes uneven, and thus, crack easily occurs during cold working.

In order to solve the above-described problem, the inventors have studied an influence of chemical composition and surface layer structure of the steel on the hydrogen embrittlement resistance and the cold workability of the steel. As a result, the inventors found that one or both of As and Sb included in the steel limits formation of the pro-eutectoid ferrite structure and the bainite structure in the surface layer structure of the steel after pearlitic transformation.

That is, the inventors found that the structure of the surface layer was improved by including one or both selected from the group consisting of As and Sb in the steel, and thus, (1) cold workability during bolt forming was improved, and (ii) hydrogen embrittlement resistance of the bolt after being formed or after heat treatment was improved.

The present invention has been made in consideration of the above-described findings, and the gist of the present invention is as follows.

(1) In a wire rod having a tensile strength of 950 to 1600 MPa for manufacturing a steel wire for a pearlite structure bolt according to one embodiment of the present invention, a chemical composition thereof includes, in terms of mass %: C: 0.35 to 0.65%; Si: 0.15 to 0.35%; Mn: 0.30 to 0.90%; P: 0.020% or less; S: 0.020% or less; Al: 0.010 to 0.050%; N: 0.0060% or less; O: 0.0030% or less; one or both selected from the group consisting of As and Sb: 0.0005 to 0.0100% in total; Cr: 0 to 0.20%; Cu: 0 to 0.05%; Ni: 0 to 0.05%; Ti: 0 to 0.02%; Mn: 0 to 0.10%; V: 0 to 0.10%; Nb: 0 to 0.02%; and a remainder including Fe and impurities, the wire rod is manufactured by hot rolling and then direct isothermal transformation treating, when the amount of C in terms of mass % is indicated as <C>, a structure at an area from a surface of the wire rod to a depth of 4.5 mm includes 140×<C> area % or more of a pearlite structure, the average block size of a pearlite block at the area from the surface of the wire rod to the depth of 4.5 mm is 20 μm or loss, in which the average block size is measured in a transverse section of the wire rod, and an average lamellar spacing of the pearlite structure at the area from the surface of the wire rod to the depth of 4.5 mm is more than 120 nm to 200 nm.

(2) In the wire rod having tensile strength of 950 to 1600 MPa for manufacturing the steel wire for the pearlite structure bolt according to (1), the chemical composition may include one or more selected from the group consisting of, in terms of mass %; Cr: 0.005 to 0.20%; Cu: 0.005 to 0.05%; Ni: 0.005 to 0.05%; Ti: 0.001 to 0.02%; Mo: 0.005 to 0.10%; V: 0.005 to 0.10%; and Nb: 0.002 to 0.02%.

(3) In a steel wire having tensile strength of 950 to 1600 MPa for a pearlite structure bolt according to the other embodiment of the present invention, the steel wire is manufactured from the wire rod having a tensile strength of 950 to 1600 MPa for manufacturing the steel wire for the pearlite structure bolt according to (1) or (2), the structure at an area from a surface of the steel wire to a depth of 2.0 mm includes 140×<C> area % or more of the pearlite structure which is wire drawn, the average aspect ratio AR of the pearlite block at the area from the surface of the steel wire to the depth of 2.0 mm is 1.2 to less than 2.0 in which the aspect ratio AR is measured in a longitudinal section of the steel wire, and the average block size of the pearlite block at the area from the surface of the steel wire to the depth of 2.0 mm is 20/AR μm or less in which the average block size is measured in a transverse section of the steel wire.

(4) In a pearlite structure bolt according to the other embodiment of the present invention, the pearlite structure bolt is manufactured from the steel wire having a tensile strength of 950 to 1600 MPa for a pearlite structure bolt according to (3), a structure at an area from a surface of a shaft pan of the pearlite structure bolt to a depth of 2.0 mm includes 140×<C> area % or more of the pearlite structure which is wire drawn, the average aspect ratio AR of the pearlite block at the area from the surface of the shaft part of the pearlite structure bolt to the depth of 2.0 mm is 1.2 to less than 2.0 in which the aspect ratio AR is measured in a longitudinal section of the pearlite structure bolt, the average block size of the pearlite block at the area from the surface of the shaft part of the pearlite structure bolt to the depth of 2.0 mm is 20/AR μm or less in which the average block size is measured in a transverse section of the pearlite structure bolt, and the tensile strength is 950 to 1600 MPa.

(5) In the pearlite structure bolt according to (4), the pearlite structure bolt may be a flange bolt.

(6) A method for manufacturing a wire rod having tensile strength of 950 to 1600 MPa for manufacturing a steel wire for a pearlite structure bolt according to the other embodiment of the present invention includes: heating a steel piece to 1000 to 1150° C., in which a chemical composition of the steel piece includes, in terms of mass %. C: 0.35 to 0.65%; Si: 0.15 to 0.35%; Mn: 0.30 to 0.90%; P: 0.020% or less; S: 0.020% or less; Al: 0.01 to 0.05%; N: 0.006% or less; O: 0.003% or less; one or both selected from the group consisting of As and Sb: 0.0005 to 0.010% in total; Cr: 0 to 0.20%; Cu: 0 to 0.05%; Ni: 0 to 0.05%; Ti: 0 to 0.02%; Mo: 0 to 0.10%; V: 0 to 0.10%; Nb: 0 to 0.02%; and remainder including Fe and impurity, hot rolling the steel piece to obtain a wire rod with a finish rolling temperature of 800 to 950° C., isothermal transformation treating by directly immersing the wire rod having temperature of 800 to 950° C. into a molten salt bath having temperature of 450 to 600° C. during 50 seconds or more, and water cooling the wire rod from 400° C. or higher to 300° C. or lower.

(7) In the method for manufacturing the wire rod having tensile strength of 950 to 1600 MPa for manufacturing the steel wire for the pearlite structure bolt according to (6), the chemical composition of the steel piece may include one or more selected from the group consisting of, in terms of mass %, Cr: 0.005 to 0.20%; Cu: 0.005 to 0.05%; Ni: 0.005 to 0.05%; Ti: 0.001 to 0.02%; Mo: 0.005 to 0.10%; V: 0.005 to 0.10%; and Nb: 0.002 to 0.02%.

(8) A method for manufacturing a steel wire having tensile strength of 950 to 1600 MPa for a pearlite structure bolt according to the other embodiment of the present invention includes: wire drawing the wire rod having a tensile strength of 950 to 1600 MPa for manufacturing the steel wire for the pearlite structure bolt according to (1) or (2) at a room temperature in which a total reduction of area is 10 to 55%.

(9) A method for manufacturing a pearlite structure bolt according to the other embodiment of the present invention includes: working the steel wire having a tensile strength of 950 to 1600 MPa for the pearlite structure bolt according to (3) into a bolt shape by cold forging or by the cold forging and form rolling to obtain a bolt; and keeping the bolt within a temperature range of 100 to 400° C. during 10 to 120 minutes.

(10) In the method for manufacturing a pearlite structure bolt according to (9), the bolt shape may be a flange bolt shape.

According to the above-described embodiments of the present invention, a high strength pearlite bolt having excellent hydrogen embrittlement resistance, a steel wire having excellent cold workability for the bolt, a wire rod having excellent cold workability for manufacturing the steel wire, and a method for manufacturing the same can be provided.

### BRIEF DESCRIPTION OF THE DRAWING

FIG. 1 A flowchart indicating an example of method for manufacturing a high strength pearlite structure bolt.

### EMBODIMENTS OF THE INVENTION

In a wire rod for manufacturing a steel wire for a pearlite structure bolt having a tensile strength of 950 to 1600 MPa according to one embodiment of the present invention, a chemical composition thereof includes: in terms of mass %: C: 0.35 to 0.65%; Si: 0.15 to 0.35%; Mn: 0.30 to 0.90%; P: 0.020% or less; S: 0.020% a or less; Al: 0.010 to 0.050%; N: 0.0060% or less; O: 0.0030% or less; one or both selected from the group consisting of As and Sb: 0.0005 to 0.0100% in total; Cr: 0 to 0.20%; Cu: 0 to 0.05%; Ni: 0 to 0.05%; Ti: 0 to 0.02%; Mo: 0 to 0.10%; V: 0 to 0.10%; Nb: 0 to 0.02%; and a remainder including Fe and impurities, the wire rod is manufactured by hot rolling and then direct isothermal transformation treating, when the amount of C in terms of mass % is indicated as <C>, the structure at an area from a surface of the wire rod to a depth of 4.5 mm includes 140×<C> area % or more of a pearlite structure, an average block size of a pearlite block at the area from the surface of the wire rod to a depth of 4.5 mm is 20 μm or less, in which the average block size is measured in a transverse section of the wire rod, and an average lamellar spacing of the pearlite structure at the area from the surface of the wire rod to the depth of 4.5 mm is more than 120 nm to 200 nm.

A steel wire having tensile strength of 950 to 1600 MPa for a pearlite structure bolt according to other embodiment of the present invention is manufactured from the above-described wire rod having a tensile strength of 950 to 1600 MPa for manufacturing the steel wire for the pearlite structure bolt, wherein a structure at an area from a surface of the steel wire to a depth of 2.0 mm includes 140×<C> area % or more of the pearlite structure which is wire drawn, an average aspect ratio AR of the pearlite block at the area from the surface of the steel wire to the depth of 2.0 mm is 1.2 or more to less than 2.0 in which the aspect ratio AR is measured in a longitudinal section of the steel wire, and the average block size of the pearlite block at the area from the surface of the steel wire to the depth of 2.0 mm is 20/AR μm or less in which the average block size is measured in a transverse section of the steel wire.

A pearlite structure bolt according to other embodiment of the present invention is manufactured from the above-described steel wire having tensile strength of 950 to 1600 MPa for a pearlite structure bolt, wherein a structure at an area from a surface of a shaft part of the pearlite structure bolt to a depth of 2.0 mm includes 140×<C> area % or more of the pearlite structure which is wire drawn, the average aspect ratio AR of the pearlite block at the area from the surface of the shaft part of the pearlite structure bolt to the depth of 2.0 mm is 1.2 to less than 2.0 in which the aspect ratio AR is measured in a longitudinal section of the pearlite structure bolt, and the average block size of the pearlite block at the area from the surface of the shaft part of the pearlite structure bolt to the depth of 2.0 mm is 20/A. R μm or less in which the average block size is measured in a transverse section of the pearlite structure bolt, and tensile strength is 950 to 1600 MPa.

At first, a chemical composition of the wire rod having a tensile strength of 950 to 1600 MPa for manufacturing the steel wire for the pearlite structure bolt (hereinafter, “wire rod”), a chemical composition of the steel wire having a tensile strength of 950 to 1600 MPa for the pearlite structure holt (hereinafter, “steel wire”), and a chemical composition of the pearlite structure bolt (hereinafter, “bolt”) will be described. The steel wire according to the present embodiment can be obtained by wire drawing the wire rod according to the present embodiment, and the bolt according to the present embodiment can be obtained by cold forging or by the cold forging and form rolling the steel wire according to the present embodiment. The wire drawing, the cold forging, and the form rolling do not affect to the chemical composition of the steel. Therefore, the descriptions regarding the chemical composition described below can be applied to either the wire rod, the steel wire, and the bolt. Hereinafter, “%” indicates “mass %”. Remainder of the chemical composition is Fe and impurity. The area from a surface of the wire rod to a depth of 4.5 mm may be referred as “surface part of wire rod”, an area from a surface of the steel wire to a depth of 2.0 mm may be referred as “surface part of steel wire”, and an area from a surface of a shaft part of the bolt to a depth of 2.0 mm may be referred as “surface part of shaft part of bolt”.

C: 0.35 to 0.65%

C is an element necessary for securing tensile strength. If the amount of C is less than 0.35%, it is difficult to obtain tensile strength of 95 MPa or more. It is preferable that the amount of C be 0.40% or more. On the other hand, if the amount of C is more than 0.65%, cold forgeability deteriorates. It is preferable that the amount of C be 0.60% or less.

Si: 0.15 to 0.35%

Si is a deoxidizing element, as well as an element enhancing tensile strength with solute strengthening. If the amount of Si is less than 0.15%, the effect is not sufficiently expressed. It is preferable that the amount of Si be 0.18% or more. On the other hand, if the amount of Si is more than 0.35%, the effect is saturated, and elongation during hot rolling deteriorates to easily generate flaws. It is preferable that the amount of Si be 0.28% or less.

Mn: 0.30 to 0.90%

Mn is an element enhancing tensile strength of the steel after pearlite transformation. If the amount of Mn is less than 0.30%, the effect is not sufficiently expressed. It is preferable that the amount of Mn be 0.40% or more. On the other hand, if the amount of Mn is more than 0.90%, the effect is saturated, and a time required for completion of transformation during isothermal transformation treatment of the wire rod is prolonged. By the prolongation of the time required for completion of transformation, the area ratio of the pearlite structure at the surface pan of the wire rod may be less than 140×<C> area % to deteriorate the hydrogen embrittlement resistance and the workability. Furthermore, by the saturation of the effect, the manufacturing cost unnecessarily increases. It is preferable that the amount of Mn be 0.80% or less.

P: 0.020% or less

P is an element which segregates at a grain boundary to deteriorate the hydrogen embrittlement resistance and which deteriorates cold workability. If the amount of P is more than 0.020%, the hydrogen embrittlement resistance and the cold workability are significantly deteriorated. It is preferable that the amount of P be 0.015% or less. It is not necessary for the wire rod, the steel wire, and the bolt according to the present embodiment to include P, and thus, the lower limit of the amount of P is 0%.

S: 0.020% or less

S is an element which segregates at the grain boundary to deteriorate the hydrogen embrittlement resistance and which deteriorates cold workability, similar to P. If the amount of S is more than 0.020%, the hydrogen embrittlement resistance and the cold workability are significantly deteriorated. The amount of S is preferably 0.015% or less, and is more preferably 0.010% or less. It is not necessary for the wire rod, the steel wire, and the bolt according to the present embodiment to include S, and thus, the lower limit of the amount of S is 0%.

Al: 0.010 to 0.050%

Al is an deoxidizing element, and an element which forms AlN which acts as a pinning particle. AlN refines grain to enhance the cold workability. In addition, Al is an element having an effect of decreasing the amount of solute N to limit dynamic strain aging and an effect of enhancing the hydrogen embrittlement resistance. If the amount of Al is less than 0.010%, the above-described effect cannot be obtained. It is preferable that the amount of Al be 0.020% or more. If the amount of Al is more than 0.050%, the above-described effect is saturated, and flaws easily occur during hot rolling. It is preferable that the amount of Al be 0.040% or less.

N: 0.0060% or less

N is an element which may deteriorate the cold workability by the dynamic strain aging and may deteriorate the hydrogen embrittlement resistance. In order to avoid such adverse effects, the amount of N is 0.0060% or less. The amount of N is preferably 0.0050% or less, and is more preferably 0.0040% or less. The lower limit of the amount of N is 0%.

O: 0.0030% or less

O exists as oxides of Al, Ti, and the like in the wire rod, the steel wire, and the steel product such as the bolt. If the amount of O is more than 0.0030%, coarse oxides form in the steel to easily occur fatigue fracture. It is preferable that the amount of O be 0.0020% or less. The lower limit of the amount of O is 0%.

As+Sb: 0.0005 to 0.0100%

As and Sb are important elements for the wire rod according to the present embodiment, the steel wire according to the present embodiment, and the bolt according to the present embodiment. Both of As and Sb segregate at the surface part of the wire rod to improve surface layer structure. Specifically, they limit generation of pro-eutectoid ferrite structure and hainite structure at the surface part of the wire rod. Thus, the hydrogen embrittlement resistance and the cold workability are improved. Therefore, in the wire rod according to the present embodiment, the steel wire according to the present embodiment, and the bolt according to the present embodiment, the total amount of one or both selected from the group consisting of As and Sb is defined.

If the total amount of one or both selected from the group consisting of As and Sb is less than 0.0005%, the above-described effect cannot be obtained. That is, in this case, the area ratio of the pearlite structure at the surface part of the wire rod is lower than the following lower limit thereof. On the other hand, if the total amount of one or both selected from the group consisting of As and Sb is higher than 0.0100%, As and Sb excessively segregate at the grain boundary to deteriorate the cold workability. It is preferable that the total amount of one or both selected from the group consisting of As and Sb be 0.0008 to 0.005%.

The reason why one or both selected from the group consisting of As and Sb improve the surface layer structure is assumed to be as below.

As and Sb segregate at the grain boundary and the surface of the wire rod, the steel wire, and the bolt. (i) Due to the segregation of the elements at the surface, decarburization at the surface is limited. In addition, (ii) due to the segregation of the elements at the grain boundary, nucleation of the ferrite and the bainite from the grain boundary is limited. By the limitation of the nucleation of the ferrite and the bainite, a structure in which the generation of the pro-eutectoid ferrite and the bainite is limited can be obtained at the surface part of the wire rod, the steel wire, and the shaft part of the bolt. In addition, the total amount of 0.0005% or more of As and Sb refine pearlite block and reduce the average lamellar spacing of the pearlite structure at the surface part of the wire rod, the steel wire, and the bolt.

The pearlite structure has a layered constitution in which cementite layer and ferrite layer are laminated. In a case in which the steel wire is manufactured by wire drawing the wire rod, a pearlite structure having systematic layered constitution can be obtained by elongating the cementite layer and the ferrite layer along drawing direction. The layered constitution prevents the hydrogen from being introduced through the surface layer, and thus, enhances the hydrogen embrittlement resistance of the steel wire and the bolt.

If the strength of the surface layer is ununiform, crack occurs at a part of which the strength is low during cold working such as forging. However, low strength structure such as pro-eutectoid ferrite, bainite, and the like are prevented from forming by including one or both selected from the group consisting of As and Sb. That is, the ununiformity of the strength at the surface layer is eliminated thereby, and thus, the cold workability increases.

In addition to the above-described elements, the wire rod according to the present embodiment, the steel wire according to the present embodiment, and the bolt according to the present embodiment may include one or more selected from the group consisting of Cr, Cu, Ni, Ti, Mo, V, and Nb. However, even if the elements are not included, the wire rod according to the present embodiment, the steel wire according to the present embodiment, and the bolt according to the present embodiment have property which is sufficient for solving the problem. Therefore, the lower limit of the amount of Cr, Cu. Ni, Ti, Mo, V, and Nb is 0%.

Cr: 0 to 0.20%

Cr is an element which enhances the tensile strength of the steel after the pearlite transformation. If the amount of Cr is less than 0.005%, the above-described effect cannot be sufficiently obtained. On the other hand, if the amount of Cr is more than 0.20%, martensite may easily form, which deteriorates the cold workability. Therefore, if Cr is included, the amount of Cr is preferably 0.005 to 0.20%, and is more preferably 0.010 to 0.15%.

Cu: 0 to 0.05%

Cu is an element which contributes to enhance the strength by precipitation hardening. If the amount of Cu is less than 0.005%, the above-described effect cannot be sufficiently obtained. On the other hand, if the amount of Cu is more than 0.05%, intergranular embrittlement occurs to deteriorate the hydrogen embrittlement resistance. Therefore, if Cu is included, the amount of Cu is preferably 0.005 to 0.05%, and is more preferably 0.010 to 0.03%.

Ni: 0 to 0.05%

Ni is an element which enhances the toughness of the steel. If the amount of Ni is less than 0.005%, the above-described effect cannot be sufficiently obtained. On the other hand, if the amount of Ni is more than 0.05%, the martensite may easily form and thereby deteriorate the cold workability. Therefore, if Ni is included, the amount of Ni is preferably 0.005 to 0.05%, and is more preferably 0.01 to 0.03%.

Ti: 0 to 0.02%

Ti is an deoxidizing element. In addition, Ti precipitates TiC to enhance the tensile strength and the yield strength. Moreover, Ti decreases the amount of solute N to enhance the cold workability. If the amount of Ti is less than 0.001%, the above-described effects cannot be obtained. On the other hand, if the amount of Ti is more than 0.02%, the above-described effect is saturated and the hydrogen embrittlement resistance is deteriorated. Therefore, if Ti is included, the amount of Ti is preferably 0.001 to 0.02%, and is more preferably 0.002 to 0.015%.

Mo: 0 to 0.10%

Mo precipitates carbides (MoC or Mo₂C) to enhance the tensile strength, the yield strength, and the proof stress. In addition, Mo is an element which enhances the hydrogen embrittlement resistance. If the amount of Mo is less than 0.005%, the above-described effects cannot be obtained. On the other hand, if the amount of Mo is more than 0.10%, material cost significantly increases. Therefore, if Mo is included, the amount of Mo is preferably 0.005 to 0.10%, and is more preferably 0.01 to 0.08%.

V: 0 to 0.10%

V precipitates carbides (VC) to enhance the tensile strength, the yield strength, and the proof stress. In addition, V is an element which contributes to enhance the hydrogen embrittlement resistance. If the amount of V is less than 0.005%, the above-described effects cannot be obtained. On the other hand, if the amount of V is more than 0.10%, material cost significantly increases. Therefore, if V is included, the amount of V is preferably 0.005 to 0.10%, and is more preferably 0.010 to 0.08%.

Nb: 0 to 0.02%

Nb precipitates carbides (NbC) to enhance the tensile strength, the yield strength, and the proof stress. If the amount of Nb is less than 0.002%, the above-described effect cannot be obtained. On the other hand, if the amount of Nb is more than 0.02%, the above-described effect is saturated. Therefore, if Nb is included, the amount of Nb is preferably 0.002 to 0.02%, and is more preferably 0.005 to 0.01%.

Next, structure of the wire rod according to the present embodiment, the steel wire according to the present embodiment, and the bolt according to the present embodiment will be described. The steel wire according to the present embodiment is obtained by wire drawing the wire rod according to the present embodiment. The bolt according to the present embodiment is obtained by cold-forging the steel wire according to the present embodiment, or by cold-forging and form rolling the steel wire according to the present embodiment. The wire drawing has an influence on the form of the pearlite. Therefore, hereinafter, each of the structures of the wire rod, the steel wire, and the bolt will be described individually.

An influence of the cold forging and the form rolling on structure of the shaft part of the bolt, which dominates the strength of the bolt, is small, since the amount of working of the cold forging and the form rolling on the shaft part of the bolt is small. In addition, an influence of the wire drawing on the area ratio of the pearlite is small. Therefore, in the present embodiment, these influences are not taken into account.

(Regarding Structure of the Wire Rod According to the Present Embodiment)

(The area ratio of the pearlite: 140×<C> area % or more at an area from a surface of the wire rod to a depth of 4.5 mm)

(The average block size of a pearlite block at the area from the surface to the depth of 4.5 mm, in which the average block size is measured in a transverse section: 20 μm or less)

(The average lamellar spacing of the pearlite structure at the area from the surface of the wire rod to a depth of 4.5 mm is more than 120 nm to 200 nm)

The wire rod according to the present embodiment is manufactured by hot rolling and then direct isothermal transformation treating. The structure at an area from a surface of the wire rod according to the present embodiment to a depth of 4.5 mm (a surface part of the wire rod) includes 140×<C> area % or more of pearlite. <C> is the amount of C (in terms of mass %) of the wire rod. If the area ratio of the pearlite at the surface part of the wire rod is less than 140×<C> area %, the area ratio of the pearlite at an area from a surface of the steel wire obtained by working the wire rod to a depth of 2.0 mm (a surface part of the steel wire) and the area ratio of the pearlite at an area from a surface of the bolt to a depth of 2.0 mm (a surface part of the bolt) become less than 140×<C> area %. In this case, the hydrogen embrittlement resistance of the steel wire and the bolt deteriorate. In addition to the pearlite, bainite, pro-eutectoid ferrite, martensite, and the like may be included in the wire rod, and the structures other than the pearlite are acceptable as long as the amount of the pearlite at the surface part of the wire rod is 140×<C> area % or more. If the area ratio of the pearlite at the surface part of the wire rod is less than 140×<C> area %, the amount of the pro-eutectoid ferrite and the amount of the bainite increase and thereby deteriorate the hydrogen embrittlement resistance of the bolt obtained from the wire rod. In addition, if the area ratio of the pearlite at the surface part of the wire rod is less than 140×<C> area %, the strength (such as the tensile strength, the hardness, and the like) of the surface part of the wire rod becomes uneven, and thus, crack easily occurs during cold working the wire rod. It is preferable that the amount of the pearlite at the surface pan of the wire rod is 145×<C> area % or more. Since it is preferable that the surface part of the wire rod does not include structures other than the pearlite, the upper limit of the amount of pearlite at the surface part of the wire rod is 100 area %.

In addition, in the wire rod according to the present embodiment, the average block size of a pearlite block at the surface part is 20 μm or less, in which the average block size is measured in a transverse section, and the average lamellar spacing of the pearlite structure at the surface pan is more than 120 nm and 200 nm or less. The term “transverse section” indicates a section perpendicular to the longitudinal direction of the wire rod.

If the average block size of the pearlite block at the surface part of the wire rod measured in a transverse section is more than 20 μm, the elongation of the wire rod decreases, and thus the cold workability of the wire rod is deteriorated. In addition, in this case, the pearlite block size at the surface part of the steel wire obtained by wire drawing the wire rod and the pearlite block size at the surface part of the bolt obtained by working the steel wire coarsen. Furthermore, if the pearlite block at the surface part coarsens, the hydrogen embrittlement resistance deteriorates, since the hydrogen has a tendency to segregate at a pearlite block boundary. If the pearlite block at the surface part of the wire rod coarsens, the total area of the pearlite block boundary at the surface part of the wire rod decreases, and thus, the hydrogen capturing capacity (i.e. a capacity for preventing the hydrogen from intruding into the wire rod) of the surface part of the wire rod deteriorates. It is preferable that the average block size of the pearlite block at the surface part of the wire rod is 15 μm or less. The average block size of the pearlite block at the surface part of the wire rod is preferably as small as possible, and thus, it is not necessary to limit the lower limit thereof. However, in view of the capacity of the manufacturing equipment, it is difficult to set the average block size of the pearlite block at the surface part of the wire rod to less than about 5 μm.

The pearlite structure is a structure in which a plurality of ferrite layer and a plurality of cementite layer are laminated. A lamellar spacing is an interval between the plurality of cementite layer. If the average lamellar spacing of the pearlite structure at the surface part of the wire rod is 120 nm or less, the deformation resistance of the wire rod increases, and thus the cold workability of the wire rod is deteriorated. On the other hand, in order to increase the average lamellar spacing of the pearlite structure at the surface part of the wire rod to more than 200 nm, it is necessary to rise pearlite transformation temperature. If the pearlite transformation temperature is risen, productivity of the wire rod according to the present embodiment deteriorates. It is preferable that the average lamellar spacing of the pearlite structure at the surface part of the wire rod is 125 to 180 nm.

Accordingly, in the pearlite structure at the surface part of the wire rod according to the present embodiment, the average block size of the pearlite block measured in the transverse section is 20 μm or less and the average lamellar spacing of the pearlite structure is more than 120 nm and 200 nm or less.

In the wire rod according to the present embodiment, an area in which the average block size of the pearlite block and the average lamellar spacing of the pearlite structure are defined is an area from a surface of the wire rod to a depth of 4.5 mm (the surface part of the wire rod). As described below, total reduction of area during wire drawing the wire rod in manufacturing the steel wire according to the present embodiment is 10 to 55%. The area from the surface of the wire rod to the depth of 4.5 mm has a depth of at least 2.0 mm from a surface of the steel wire or a surface of the bolt after the wire drawing with the reduction of area of 10 to 55%. In the steel wire obtained by wire drawing the wire rod according to the present embodiment, it is necessary to control the average block size of the pearlite block at the area from the surface of the steel wire to the depth of 2.0 mm (the surface part of the steel wire). By defining the constitution of the pearlite at the area from the surface of the wire rod to the depth of 4.5 mm in the wire rod, the constitution of the pearlite at the area from the surface to the depth of 2.0 mm in the steel wire obtained by the wire rod can be optimized.

In the present embodiment, the pearlite block boundary is defined as a boundary of two pearlites adjacent to each other in which orientation difference of ferrite in the pearlites is 15 degrees or more, the pearlite block is defined as an area surrounded by the pearlite block boundary, and the average block size of the pearlite block is an average value of circle equivalent diameter of the pearlite block. The average block size of the pearlite block at the surface part of the wire rod can be obtained by, at first, measuring the average value of the circle equivalent diameter of the pearlite block at the depth of 4.5 mm from the surface in transverse section of the wire rod at 8 points at intervals of 45° with EBSD device, and then, calculating an average value of the measuring results at the 8 points. The average lamellar spacing at the surface part of the wire rod is measured by the following procedures. At first, the pearlite structure is developed by etching the transverse section of the wire rod with picral, and then, photographs of the pearlite structure at a depth of 4.5 mm from the surface of the wire rod are taken at 8 points at intervals of 45° with FE-SEM. The photographs are taken at 10000-fold magnification. At a position in which the lamellar spacing is minimum in each pictures, a number of lamellar which perpendicularly cross a line of 2 μm is obtained, and the lamellar spacing is obtained with linear crossing method. In addition, the average value of the lamellar spacing at the 8 points is assumed as the average lamellar spacing. In the present embodiment, the area ratio of the pearlite at the surface part of the wire rod is obtained by the following procedures. At first, the structure is developed by etching the transverse section of the wire rod with the picral. Next, photographs of the structure at a depth of 4.5 mm from the surface of the wire rod are taken at 8 points at intervals of 45° with FE-SEM. The photographs are taken at 1000-fold magnification. Non-pearlite structures (ferrite, bainite, and martensite) are visually marked and the area ratio thereof are obtained by image analysis. The area ratio of the pearlite structure can be obtained by subtracting the area of the structures from all over the observation field.

(Regarding Structure of the Steel Wire According to the Present Embodiment)

(The area ratio of the pearlite is 140×<C area % or more).

(The average aspect ratio AR of the pearlite block at the area from the surface to the depth of 2.0 mm, which is measured in a longitudinal section is 1.2 or more and less than 2.0).

(The average block size of a pearlite block at the area from the surface to the depth of 2.0 mm, in which the average block size is measured in a transverse section is (20/AR) μm or less).

In the steel wire according to the present embodiment, which is manufactured by wire drawing the wire rod according to the present embodiment, an area ratio of the pearlite at the area from the surface of the surface thereof to the depth of 2.0 mm is 140×<C> area % or more. When the following wire drawing is applied to the wire rod according to the present embodiment, an area ratio of the surface pan of the steel wire is 140×<C> area % or more. The average aspect ratio (AR) of the pearlite block at the surface part of the steel wire according to the present embodiment, which is measured in a longitudinal section, is 1.2 or more and less than 2.0, and the average block size at the surface part of the steel wire according to the present embodiment, which is measured in a transverse section, is (20/AR) μm or less. The term “longitudinal section” indicates a section parallel to the longitudinal direction of the steel wire. The term “aspect ratio” indicates a ratio of long axis and short axis. i.e. “length of long axis/length of short axis” of the pearlite block. The average aspect ratio of the pearlite block at the surface part of the steel wire measured in the longitudinal section can be obtained by the following procedures. At first, an average aspect ratio at 8 points in a position having depth of 2.0 mm from the surface in the longitudinal section of the wire rod is obtained with EBSP. Next, a value obtained by further calculating the average value of the average aspect ratio at each points is assumed to be the average aspect ratio in the present embodiment.

In order to provide an excellent hydrogen embrittlement resistance to the high strength bolt having tensile strength of 950 to 1600 MPa, it is effective to elongate the pearlite block at the surface part of the steel wire which is material of the bolt along to the drawing direction. The pearlite structure has a laminated constitution of cementite layer and ferrite layer. The laminated constitution acts as resistance against introduction of hydrogen through the surface layer (hydrogen embrittlement resistance). When the pearlite block at the surface part of the steel wire is elongated along to the drawing direction, orientation of the layered constitution of the pearlite structure at the surface part of the steel wire is made uniform to further enhance the hydrogen embrittlement resistance. If the average aspect ratio of the pearlite block at the surface pan of the steel wire measured in the longitudinal section is less than 1.2, the average aspect ratio of the pearlite block of the surface part of the bolt manufactured from the steel wire measured in the longitudinal section is less than 1.2. In this case, the above-described effects cannot be obtained and the resistance against the introduction of the hydrogen from surface is not sufficiently enhanced, and thus, the hydrogen embrittlement resistance of the bolt according to the present embodiment is not enhanced. On the other hand, if the average aspect ratio of the pearlite block is more than 2.0, drawing strain increases to deteriorate productivity of the bolt according to the present embodiment.

Therefore, in the pearlite structure at the surface part of the steel wire according to the present embodiment, the average aspect ratio (AR) of the pearlite block measured in the longitudinal section is needed to be 1.2 to 2.0, and is preferably 1.4 to 1.8.

Since the pearlite block is elongated along to the drawing direction by wire drawing, the average block size of the pearlite block measured in the transverse section after the wire drawing is smaller than the average block size of the pearlite block measured in the transverse section before the wire drawing. If the average block size of the pearlite block at the surface part of the steel wire according to the present embodiment measured in the transverse-section is more than (20/AR) μm, the elongation of the steel wire decreases, and thus the cold workability deteriorates. In addition, in this case, the pearlite block at the surface part of the bolt manufactured from the steel wire coarsens and thereby deteriorates the hydrogen embrittlement resistance. Typically, (20/AR) of the steel wire according to the present embodiment is about 10 to 17 μm.

Therefore, the average block size of the pearlite structure at the surface part of the steel wire according to the present embodiment measured in the transverse section is (20/AR) μm or less.

(Regarding Structure of the Bolt According to the Present Embodiment)

(Structure of a shaft part: pearlite structure having 140×<C> area % or more of area ratio which is wire drawn)

(The average aspect ratio AR of pearlite block at an area from a surface of the shaft pen to a depth of 2.0 mm, which is measured in a longitudinal section is 1.2 or more and less than 2.0)

(The average block size of the pearlite block at the area from the surface of the shaft part to the depth of 2.0 mm, which is measured in a transverse section is (20/AR) μm or less).

(The tensile strength is 950 to 1600 MPa)

In the bolt according to the present embodiment, which is manufactured by working the steel wire according to the present embodiment, the structure include 140×<C> area % or more of pearlite structure which is wire drawn at the surface part of the shaft part of the bolt. When the following method for manufacturing is applied to the steel wire according to the present embodiment, the area ratio of the pearlite at the surface part of the bolt according to the present embodiment is 140×<C> area %. In addition, at the surface part of the shaft part of the bolt according to the present embodiment, the average aspect ratio (AR) of the pearlite block measured in a longitudinal section is 1.2 to 2.0, and the average block size measured in a transverse section is (20/AR) μm or less. The bolt according to the present embodiment is a high strength bolt having tensile strength of 950 to 1600 MPa.

The average aspect ratio (AR) of the pearlite block measured in the longitudinal section and the average block size measured in the transverse section at the surface part of the bolt according to the present embodiment are similar to those of the above-described steel wire according to the present embodiment.

Since hydrogen embrittlement phenomenon hardly occurs in a bolt having tensile strength of less than 950 MPa, it is not necessary to use the steel wire according to the present embodiment for manufacturing the bolt. Therefore, the tensile strength of the bolt according to the present embodiment is 950 MPa or more.

On the other hand, it is difficult to manufacture a bolt having tensile strength of more than 1600 MPa with the cold forging. Even if such bolt can be manufactured, a yield rate is low and the manufacturing cost is high, and thus, the tensile strength of the bolt according to the present embodiment is 1600 MPa or less. A chemical composition of the bolt according to the present embodiment is equal to the chemical composition of the above-described wire rod according to the present embodiment, and the tensile strength of 950 to 1600 MPa is archived by the chemical composition and the form of the structure.

By wire drawing the pearlite structure in which the cementite layer and the ferrite layer form laminated constitution, pearlite structure in which the cementite layer and the ferrite layer are elongated along the drawing direction and which has systematic layered constitution can be obtained. The term “systematic” indicates that the orientation of the layers constructing the layered constitution is uniform. The layered constitution acts as resistance against introduction of hydrogen through the surface layer to enhance the hydrogen embrittlement resistance of the bolt according to the present embodiment.

In the steel wire according to the present embodiment and the bolt according to the present embodiment, it is not necessary to define the lamellar spacing of the pearlite structure. When the steel wire according to the present embodiment and the bolt according to the present embodiment are manufactured by applying the following method, for manufacturing to the above-described wire rod according to the present embodiment, typically, the lamellar spacing at the surface part of the steel wire and the bolt according to the present embodiment is 100 to 160 nm. In this case, the lamellar spacing does not provide bad influence to the steel wire and the bolt according to the present embodiment.

Therefore, the bolt according to the present embodiment, which has high strength such as tensile strength of 950 in 1600 MPa, and which has excellent hydrogen embrittlement resistance, is best for a bolt used for fastening chassis parts, engine parts, and the like of vehicle.

Next, a method for manufacturing the wire rod according to the present embodiment, a method for manufacturing the steel wire according to the present embodiment, and a method for manufacturing the bolt according to the present embodiment will be described.

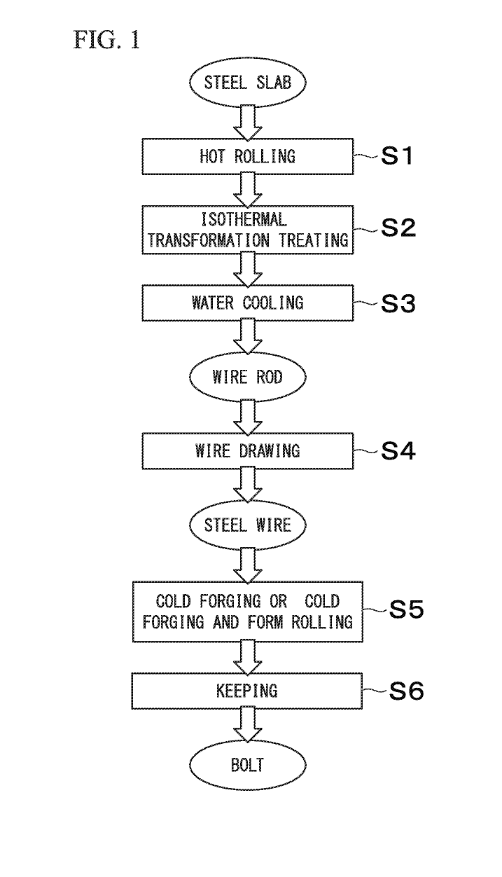

The wire rod, the steel wire, and the bolt according to the present embodiment are manufactured by the method for manufacturing shown in FIG. 1.

A method for manufacturing a wire rod having tensile strength of 950 to 1600 MPa for manufacturing a steel wire for a pearlite structure bolt according to the present embodiment includes: heating a steel piece to 1000 to 1150° C., in which a chemical composition of the steel piece includes, in terms of mass %. C: 0.35 to 0.65%; Si: 0.15 to 0.35%; Mn: 0.30 to 0.90%; P: 0.020% or less; S: 0.020% or less; Al: 0.01 to 0.05%; N: 0.006% or less: O: 0.003% or less; one or both selected from the group consisting of As and Sb: 0.0005 to 0.0100% in total; Cr: 0 to 0.20%; Cu: 0 to 0.05%; Ni: 0 to 0.05%; Ti: 0 to 0.02%; Mo: 0 to 0.10%; V: 0 to 0.10%; Nb: 0 to 0.02%; and remainder including Fe and impurity, hot rolling the steel piece to obtain a wire rod with a finish rolling temperature of 800 to 950° C., isothermal transformation treating by directly immersing the wire rod having temperature of 800 to 950° C. into a molten salt bath having temperature of 450 to 600° C. during 50 seconds or more, and water cooling the wire rod from 400° C. or higher to 300° C. or lower. The chemical composition of the steel piece is equal to the above-described chemical composition of the wire rod, the steel wire, and the bolt.

A molten metal having above-described chemical composition is casted with normal method to obtain a cast piece, and the cast piece is changed to a steel piece with normal method. The steel piece is heated to 1000 to 1150° C., and then hot rolled (S1) to obtain a wire rod. If the heating temperature before the hot rolling S1 is lower than 1000° C., deformation resistance during the hot rolling S1 increases and thereby deteriorates productivity. In addition, if the heating temperature before the hot rolling S1 is higher than 1150° C., decarburized layer depth at the surface of the wire rod increases. In this case, the average block size at the surface part of the wire rod and the average lamellar spacing at the surface pat of the wire rod increases.

In order to obtain uniform pearlite structure during subsequent isothermal transformation treating, it is important to adequately control a size of austenite. Finish rolling temperature in the hot rolling S1 affect to the size of the austenite before pearlite transformation. In order to obtain uniform pearlite structure, the finish rolling temperature in the hot rolling S1 is 800 to 950° C.

If the finish rolling temperature is lower than 800° C., rolling load increases, and thus, productivity is deteriorated. If the finish rolling temperature is higher than 950° C., the finish rolling temperature is too high to coarsen the austenite grain size. In this case, the pearlite block at the surface part of the wire rod coarsens and deteriorates the hydrogen embrittlement resistance.

After the finish rolling, the wire rod having temperature of 800 to 950° C. is served to isothermal transformation treating S2 by directly immersing into a molten salt bath having temperature of 450 to 600° C. during 50 seconds or more. The term “directly” indicates that the wire rod after the finish rolling is not cooled and reheated before immersing into the molten salt bath. If the temperature of the molten salt bath is lower than 450° C. bainite forms at the surface part of the wire rod to decrease the area ratio of the pearlite at the surface part of the wire rod to less than 140×<C> area %. In this case, the hydrogen embrittlement resistance deteriorates. In addition, if the temperature of the molten salt bath is lower than 450° C., the average lamellar spacing at the surface part of the wire rod, and thus the workability of the wire rod is deteriorated. If the temperature of the molten salt bath is higher than 600° C. initiation of the pearlite transformation delays to deteriorate productivity. In addition, if the temperature of the molten salt bath is higher than 600° C., the pearlite transformation temperature of the wire rod rises to increase the average block size of the pearlite block at the surface part of the wire rod to more than 20 μm. Moreover, if the temperature of the molten salt bath is higher than 600° C., the pearlite transformation temperature of the wire rod rises to increase the average lamellar spacing of the pearlite structure at the surface part of the wire rod to more than 200 nm. If the immersing time into the molten salt bath is less than 50 sec, the pearlite transformation does not sufficiently progress, and thus, 140×<C> area % or more of the pearlite cannot form at the surface part of the wire rod. Although the upper limit of the immersing time into the molten salt both is not defined, immersing with about 150 sec or more does not contribute improvement of the property of the wire rod as well as deteriorates productivity.

Duration between the termination of the finish rolling and the initiation of the immersing into the molten salt bath is not defined. On the other hand, it is necessary to start the immersing into the molten salt bath in a state in which the temperature of the wire rod is 800 to 950° C. In addition, it is necessary to directly immerse it into the molten salt hath after the finish rolling. That is, it is necessary that the wire rod is immersed into the molten salt bath before the temperature of the wire rod after termination of the finish rolling falls to less than 800° C. Therefore, it is necessary to control the duration between the termination of the finish rolling and the initiation of the immersing into the molten salt bath to satisfy the conditions in consideration of the temperature in the atmosphere of the manufacturing equipment.

In the immersing the wire rod into the molten salt bath, in order to enhance productivity, the wire rod may be immersed into a plurality of molten salt bath in order, which have different temperature. When such a method is adopted, the temperature in each molten salt bathes may be within a range of 450 to 600° C. and the total immersing time in each molten salt both may be 50 sec or more.

Alter the isothermal transformation treating S2, the wire rod is water cooled (S3). It is necessary that starting temperature of the water cooling S3 is 400° C. or more and finishing temperature of the water cooling S3 is 300° C. or less. If the water cooling conditions are not satisfied, scale peelability of the wire rod deteriorates.

By a series of the treatments, a wire rod having excellent cold workability, in which a structure at a surface part of the wire rod includes 140×<C> area % or more of a pearlite structure, an average block size of a pearlite block at the surface part of the wire rod measured in a transverse section of the wire rod is 20 μm or less, and an average lamellar spacing of the pearlite structure at the surface part of the wire rod is more than 120 nm to 200 nm, can be manufactured.

A method for manufacturing a steel wire having tensile strength of 950 to 1600 MPa for a pearlite structure bolt according to the present embodiment includes: wire drawing the wire rod having tensile strength of 950 to 1600 MPa for manufacturing the steel wire for the pearlite structure bolt according to the present embodiment at a room temperature in which a total reduction of area is 10 to 55%. By the method for manufacturing, a pearlite structure in which an average aspect ratio AR of a pearlite block measured in a longitudinal section is 1.2 to 2.0 and an average block size measured in a transverse section is (20/AR) μm or less is formed at a surface part of the steel wire. The layered constitution of the pearlite structure acts as resistance against introduction of hydrogen through a surface of the steel wire into the steel wire (hydrogen embrittlement resistance).

If the average aspect ratio at the surface part of the steel wire measured in the longitudinal section is less than 1.2, orientation of the layered constitution of the pearlite structure becomes uneven, and thus, the hydrogen embrittlement resistance of the steel wire does not increase. If the above-described average aspect ratio is more than 2.0, wire drawing with high reduction of area is needed, and thus, the productivity and cold workability deteriorates.

If the average block size at the surface part of the steel wire measured it the transverse section is more than (20/AR) μm, elongation of the material and cold workability deteriorate. As described above. (20/AR) of the steel wire and the bolt according to the present embodiment is typically about 10 to 17 μm.

The term “room temperature” in the method for manufacturing the steel wire according to the present embodiment is 20±15° C.

If the total reduction of area is less than 10%, it is difficult to form the pearlite structure, in which the average aspect ratio of the pearlite block is 1.2 or more, at the surface part of the steel wire. If the total reduction of area is 55% or more, the average aspect ratio of the pearlite block becomes more than 2.0 and thereby deteriorates the cold workability.

The reduction of area of 10 to 15% in the wire drawing S4 may be achieved with one-time wire drawing or may be achieved with a plurality of wire drawing. It is preferable that the total reduction of area is 30 to 45%.

A method for manufacturing a pearlite structure bolt according to the present embodiment includes: working the steel wire having tensile strength of 950 to 1600 MPa for the pearlite structure bolt according to the present embodiment so as to be a bolt shape by cold forging or by the cold forging and form rolling to obtain a bolt; and keeping the bolt within a temperature range of 100 to 400° C. during 10 to 120 minutes. If the keeping temperature in the keeping S6 after the cold forging or the cold forging and the form rolling S5 is less than 100° C., proof stress of the bolt deteriorates, and thus, functions necessary for the bolt cannot be obtained. If the keeping temperature in the keeping S6 is more than 400° C., the average aspect ratio AR of the pearlite block at the surface part of the shaft part of the bolt measured in the transverse section increases to deteriorate the hydrogen embrittlement resistance and the strength of the bolt. It is preferable that the bolt shape is a flange bolt shape. The keeping time within the temperature range of 100 to 400° C. is 10 to 120 minutes. If the keeping time is less than 10 minutes, the above-described effects cannot be obtained. If the keeping time is more than 120 minutes, the above-described effects are saturated to increase the manufacturing cost. After termination of the keeping, the bolt may be cooled to the mom temperature. The method for cooling and the cooling rate are not limited.

The steel wire according to the present embodiment has excellent cold workability, and thus, a flange bolt having circular conic flange can be manufactured by the cold forging or the cold forging and the form rolling.

The flange bolt manufactured from the steel wire according to the present embodiment has an high strength, i.e. tensile strength of 950 to 1600 MPa and excellent hydrogen embrittlement resistance, and thus, is best for the bolt used for fastening chassis parts, engine parts, and the like of vehicle.

### EXAMPLES

Next, Examples according to the present invention will be described. Conditions for Examples are merely examples of conditions used for checking applicability and effects of the present invention, and conditions for the present invention are not limited to these examples of conditions. Further, various conditions may be employed in the present invention within the scope of the present invention, provided that the objects of the present invention can be achieved.

### Example 1

Steel pieces having chemical composition disclosed in Table 1 was heated and hot rolled to obtain wire rods, and the wire rods were isothermal transformation treated and subsequently cooled. At that time, cooling start temperature for all of example wire rods and comparative example wire rods was 450° C., and cooling stop temperature for all of example wire rods and comparative example wire rods was 280° C. The average block size, average lamellar spacing, and area ratio of pearlite at the surface part (the area from a surface of the wire rod to a depth of 4.5 mm) of the example wire rods and the comparative example wire rods were measured. The average block size of the pearlite block at the surface part of the wire rod was measured by, at first, measuring an average value of a circle equivalent diameter of the pearlite block at a depth of 4.5 mm from the surface in transverse section of the wire rod at 8 points at intervals of 45 with EBSD device, and then, calculating the average value of the measuring results at the 8 points. The average lamellar spacing of the pearlite structure at the surface part of the wire rod was measured by the below procedures. At first, the pearlite structure was developed by etching the transverse section of the wire rod with picral, and then, photographs of the pearlite structure at a depth of 4.5 mm from the surface of the wire rod were taken at 8 points at intervals of 45° with FE-SEM. The photographs were taken at 10000-fold magnification. At a position in which the lamellar spacing was minimum in each pictures, a number of lamellar which perpendicularly cross a line of 2 μm was obtained, and the lamellar spacing was obtained with linear crossing method. In addition, the average value of the lamellar spacing at the 8 points was assumed as the average lamellar spacing. The area ratio of the pearlite at the surface part of the wire rod was obtained by the below procedures. At first, the structure was developed by etching the transverse section of the wire rod with picral. Next, photographs of the structure at a depth of 4.5 mm from the surface of the wire rod were taken at 8 points at intervals of 45° with FE-SEM. The photographs were taken at 1000-fold magnification. Non-pearlite structures (ferrite, bainite, and martensite) were visually marked and the area ratio thereof were obtained by image analysis. The area ratio of pearlite was obtained by subtracting the area of the structures from all over the observation field. Table 2 shows the heating temperature, the finish rolling temperature, the condition for isothermal transformation treating, and the average block size and the average lamellar spacing of the pearlite structure at the surface part.

[Table 1]

[Table 2]

In the comparative example wire rod 2 in which the average lamellar spacing (nm) of the pearlite structure at the surface part of the wire rod was out of the range of more than 120 nm and 200 nm or less, in the comparative example wire rod 1 and 6 in which the average block size at the surface part of the wire rod was out of the range of the present invention, and in the comparative example 3, 4, and 5 in which both of the average lamellar spacing and the average block size at the surface part of the wire rod were out of the range of the present invention, as shown in Table 3, limit compressibility after wire drawing was 72% or less.

On the other hand, in the example wire rod 1 to 7 in which the average lamellar spacing (nm) of the pearlite structure at the surface part of the wire rod was within the range of more than 120 nm and 200 nm or less and in which the average block size at the surface part of the wire rod was within the range of the present invention, the limit compressibility after wire drawing was 78% or more. In view of the results, it appeared that the cold workability of the example wire rod was better than that of the comparative example wire rod.

### Example 2

Steel wires were manufactured by wire drawing with total reduction of area of 5 to 70% the example wire rod 1 to 7 and the comparative example wire rod 1 to 7 shown in Table 2, and the limit compressibility of the steel wires were manufactured. The results are shown in Table 3.

The limit compressibility is an index indicating cold workability. The limit compressibility was measured by the following procedure. Steel wires after wire drawing were machined to manufacture test pieces having a diameter D and a height 1.5 D. Edge surfaces of the test pieces were constrained and compressed by a metal mold having concentric grooves. The maximum compression ratio which did not cause crack was assumed as the limit compressibility of the test piece.

[Table 3]

In the comparative example steel wire 1, 3, 4, 5, and 6 in which the average block size at the surface part of the steel wire was out of the range of the present invention, and in the comparative example steel wire 7 and 8 in which the average aspect ratio of the pearlite block grain at the surface part of the steel wire was out of the range of the present invention, the limit compressibility was less than 71% and lower than that in the example steel wires. Accordingly, it appeared that the example steel wire had excellent cold workability. Although the comparative example steel wire 2 had a structure which was within the range or the present invention, the comparative example steel wire 2 was made from the comparative example wire rod 2 in which the lamellar spacing at the surface part of the steel wire was too small, and thus, the limit compressibility thereof was low. Although the comparative example steel wire 9 had a structure which was within the range of the present invention, the total amount of Sb and As was excess, and thus, the limit compressibility thereof was low.

### Example 3

The example steel wire 1 to 7 and the comparative example steel wire 1 to 9 shown in the Table 3 were cold forged to be flange bolts. After the working, the bolts were kept in 300 to 450° C. to manufacture bolts. Temperature keeping time for all bolts was 30 minutes. The measuring results of tensile strength, proof stress ratio, and hydrogen embrittlement resistance of the shaft parts of the bolts are shown in Table 4.

Evaluation of hydrogen embrittlement resistance was performed by the following procedure. At first, 0.5 ppm of diffusible hydrogen was included in the test pieces by electrolytic hydrogen charging the test pieces. Next, the test pieces were Cr plated in order to prevent the hydrogen from discharging from the test pieces to atmosphere. Thereafter, loads which were 90% of the maximum tensile loads of the test pieces were loaded to the test pieces in atmosphere. A test piece in which crack did not occur after 100 h of loading was determined as a test piece having good hydrogen embrittlement resistance.

Measuring the proof stress ratio was performed by the following procedures. At first, tensile strength and proof stress of the test pieces were measured by performing tensile test in accordance with JIS Z 2241 to the test pieces. The proof stress of the test pieces were assumed as stress by which plastic elongation of the test pieces became 0.2% of gauge length of extensometer, in accordance with offset method described in JIS Z 2241. The proof stress ratio was calculated by dividing the proof stress with the tensile strength.

[Table 4]

In the comparative steel wire 2, 8, and 11, crack occurred during boll forming. Tensile strength of a shaft part of a bolt manufactured by cold forging the comparative steel wire 7 was less than 950 MPa. In comparative example bolt 10 in which the average aspect ratio of the pearlite block at the surface part of the shaft part of the bolt was out of the range of the present invention, and in comparative example 1, 3, 4, 5, and 6 in which the average block size was out of the range of the present invention, the hydrogen embrittlement resistance was bad. Although comparative example bolt 7 had good hydrogen embrittlement resistance, this originated from small total reduction of area during drawing and tensile strength of less than 950 MPa. The hydrogen embrittlement hardly occurs in steel having low tensile strength. The workability of the comparative example bolt 12 was bad, since the area ratio of the pearlite at the surface part thereof was low.

It was appeared that the entire example bolt 1 to 7 which satisfied the range of the present invention had tensile strength within the range of 950 to 1600 MPa, 0.93 or more of proof stress ratio, and good hydrogen embrittlement resistance.

### INDUSTRIAL APPLICABILITY

As described above, the present invention can provide a pearlite structure bolt having excellent hydrogen embrittlement resistance and tensile strength of 950 to 1600 MPa for vehicle, a steel wire having excellent cold workability for the bolt, a wire rod having excellent cold workability for manufacturing the steel wire, and methods for manufacturing the same. Accordingly, the present invention has high applicability in an industry manufacturing steel parts.

TABLE 1

| STEEL | | | | | | | | | | | | OPTIONAL | |
|---|---|---|---|---|---|---|---|---|---|---|---|---|---|
| TYPE | C | Si | Mn | P | S | Al | N | O | As | Sb | As + Sb | ELEMENT | REMARKS |
| A | 0.38 | 0.21 | 0.75 | 0.012 | 0.010 | 0.032 | 0.0039 | 0.0013 | 0.0030 | 0.0007 | 0.0037 | | WITHIN A |
| B | 0.39 | 0.24 | 0.71 | 0.011 | 0.009 | 0.024 | 0.0032 | 0.0016 | 0.0040 | — | 0.0040 | Cr: 0.13%, Mo: 0.06% | RANGE OF |
| C | 0.44 | 0.22 | 0.77 | 0.010 | 0.008 | 0.025 | 0.0028 | 0.0009 | — | 0.0012 | 0.0012 | Cu: 0.02%, Ni: 0.03% | THE PRESENT |
| D | 0.45 | 0.22 | 0.73 | 0.009 | 0.006 | 0.021 | 0.0032 | 0.0008 | 0.0030 | 0.0006 | 0.0036 | | INVENTION |
| E | 0.52 | 0.25 | 0.75 | 0.019 | 0.012 | 0.020 | 0.0042 | 0.0011 | 0.0030 | 0.0005 | 0.0035 | | |
| F | 0.57 | 0.19 | 0.83 | 0.013 | 0.007 | 0.033 | 0.0034 | 0.0009 | — | 0.0009 | 0.0009 | Ti: 0.009%, V: 0.04% | |
| G | 0.62 | 0.23 | 0.66 | 0.009 | 0.008 | 0.022 | 0.0031 | 0.0009 | 0.0030 | — | 0.0030 | Nb: 0.01% | |
| H | 0.45 | 0.21 | 0.74 | 0.012 | 0.008 | 0.031 | 0.0037 | 0.0010 | — | — | — | | NOT WITHIN |
| I | 0.52 | 0.24 | 0.72 | 0.008 | 0.010 | 0.027 | 0.0035 | 0.0008 | — | — | — | | A RANGE OF |
| J | 0.57 | 0.20 | 0.79 | 0.011 | 0.009 | 0.031 | 0.0032 | 0.0012 | — | — | — | | THE PRESENT |
| K | 0.57 | 0.22 | 0.82 | 0.019 | 0.013 | 0.035 | 0.0041 | 0.0010 | — | 0.0113 | 0.0113 | | INVENTION |

AN UNDERLINED VALUE WAS OUT OF THE RANGE OF THE PRESENT INVENTION
A SYMBOL “—” INDICATES THAT THE ELEMENT THEREOF WAS NOT PERPOSELY ADDED.
THE UNIT OF VALUES INDICATING AMOUNT OF ELEMENT WAS “MASS %”

TABLE 2

| | | | | | MOLTEN | MOLTEN | MOLTEN |
|---|---|---|---|---|---|---|---|
| | | | | FINISH | SALT | SALT | SALT |
| | | | HEATING | ROLLING | BATH 1 | BATH 1 | BATH 2 |
| | STEEL | DIAMETER | TEMPERATURE | TEMPERATURE | TEMPERATURE | KEEPING TIME | TEMPERATURE |
| | TYPE | (mm) | (° C.) | (° C.) | (° C.) | (s) | (° C.) |
| EXAMPLE WIRE ROD 1 | A | 15.0 | 1060 | 890 | 470 | 30 | 560 |
| EXAMPLE WIRE ROD 2 | B | | 1070 | 890 | 480 | 20 | 570 |
| EXAMPLE WIRE ROD 3 | C | | 1110 | 940 | 510 | 25 | 540 |
| EXAMPLE WIRE ROD 4 | D | | 1080 | 930 | 510 | 25 | 540 |
| EXAMPLE WIRE ROD 5 | E | | 1100 | 930 | 480 | 30 | 550 |
| EXAMPLE WIRE ROD 6 | F | | 1090 | 940 | 490 | 30 | 550 |
| EXAMPLE WIRE ROD 7 | G | | 1120 | 950 | 540 | 35 | 560 |
| COMPARATIVE EXAMPLE | B | | 1090 | 760 | 490 | 35 | 560 |
| WIRE ROD 1 | | | | | | | |
| COMPARATIVE EXAMPLE | D | | 1100 | 940 | 400 | 30 | 550 |
| WIRE ROD 2 | | | | | | | |
| COMPARATIVE EXAMPLE | E | | 1200 | 940 | 490 | 30 | 550 |
| WIRE ROD 3 | | | | | | | |
| COMPARATIVE EXAMPLE | H | | 1080 | 930 | 490 | 30 | 550 |
| WIRE ROD 4 | | | | | | | |
| COMPARATIVE EXAMPLE | I | | 1070 | 930 | 480 | 30 | 550 |
| WIRE ROD 5 | | | | | | | |
| COMPARATIVE EXAMPLE | J | | 1100 | 940 | 470 | 30 | 550 |
| WIRE ROD 6 | | | | | | | |
| COMPARATIVE EXAMPLE | K | | 1100 | 940 | 490 | 30 | 550 |
| WIRE ROD 7 | | | | | | | |
| COMPARATIVE EXAMPLE | F | | 1100 | 940 | 490 | 15 | 550 |
| WIRE ROD 8 | | | | | | | |

| | | | | | AREA RATIO |
|---|---|---|---|---|---|
| | MOLTEN | MOLTEN | AVERAGE BLOCK | AVERAGR LAMELLAR | OF PEARLITE |
| | SALT | SALT | SIZE AT | SPACING AT | AT SURFACE |
| | BATH 2 | BATH TOTAL | SURFACE PART | SURFACE PART | PART OF |
| | KEEPING TIME | KEEPING TIME | OF WIRE ROD | OF WIRE | WIRE ROD |
| | (s) | (s) | (μm) | (nm) | (%) |
| EXAMPLE WIRE ROD 1 | 55 | 85 | 9.8 | 173 | 69 |
| EXAMPLE WIRE ROD 2 | 30 | 50 | 10.5 | 168 | 71 |
| EXAMPLE WIRE ROD 3 | 45 | 70 | 12.2 | 179 | 78 |
| EXAMPLE WIRE ROD 4 | 45 | 70 | 11.7 | 180 | 79 |
| EXAMPLE WIRE ROD 5 | 55 | 85 | 12.6 | 156 | 88 |
| EXAMPLE WIRE ROD 6 | 55 | 85 | 15.4 | 151 | 92 |
| EXAMPLE WIRE ROD 7 | 60 | 95 | 18.1 | 158 | 94 |
| COMPARATIVE EXAMPLE | 60 | 95 | 31.3 | 192 | 59 |
| WIRE ROD 1 | | | | | |
| COMPARATIVE EXAMPLE | 55 | 85 | 12.1 | 103 | 61 |
| WIRE ROD 2 | | | | | |
| COMPARATIVE EXAMPLE | 45 | 75 | 26.7 | 242 | 90 |
| WIRE ROD 3 | | | | | |
| COMPARATIVE EXAMPLE | 45 | 75 | 22.7 | 243 | 54 |
| WIRE ROD 4 | | | | | |
| COMPARATIVE EXAMPLE | 45 | 75 | 24.9 | 224 | 71 |
| WIRE ROD 5 | | | | | |
| COMPARATIVE EXAMPLE | 45 | 75 | 23.6 | 191 | 76 |
| WIRE ROD 6 | | | | | |
| COMPARATIVE EXAMPLE | 55 | 85 | 18.1 | 162 | 90 |
| WIRE ROD 7 | | | | | |
| COMPARATIVE EXAMPLE | 20 | 35 | 15.1 | 149 | 70 |
| WIRE ROD 8 | | | | | |

AN UNDERLINED VALUE WAS OUT OF THE RANGE OF THE PRESENT INVENTION

TABLE 3

| | | | | | AVERAGE | LIMIT |
|---|---|---|---|---|---|---|
| | | | AVERAGE ASPECT | | BLOCK | COMPRESS- |
| | | TOTAL | RATIO AR OF | | SIZE AT | IBILITY |
| | | REDUCTION | PEARLITE | | SURFACE PART | AFTER WIRE |
| | | OF AREA | BLOCK AT | 20/AR | OF STEEL WIRE | DRAWING |
| | MATERIAL WIRE ROD | (%) | SURFACE PART OF | (μm) | (μm) | (%) |
| EXAMPLE STEEL WIRE 1 | EXAMPLE WIRE ROD 1 | 30 | 1,2 | 16.7 | 8.7 | 80 OR MORE |
| EXAMPLE STEEL WIRE 2 | EXAMPLE WIRE ROD 2 | 30 | 1.4 | 14.3 | 7.7 | 78 |
| EXAMPLE STEEL WIRE 3 | EXAMPLE WIRE ROD 3 | 30 | 1.3 | 15.4 | 9.3 | 79 |
| EXAMPLE STEEL WIRE 4 | EXAMPLE WIRE ROD 4 | 30 | 1.2 | 16.7 | 10.2 | 80 OR MORE |
| EXAMPLE STEEL WIRE 5 | EXAMPLE WIRE ROD 5 | 30 | 1.3 | 15.4 | 10.3 | 80 OR MORE |
| EXAMPLE STEEL WIRE 6 | EXAMPLE WIRE ROD 6 | 30 | 1.4 | 14.3 | 12.4 | 79 |
| EXAMPLE STEEL WIRE 7 | EXAMPLE WIRE ROD 7 | 30 | 1.4 | 14.3 | 11.8 | 78 |
| COMPARATIVE EXAMPLE | COMPARATIVE EXAMPLE | 30 | 1.5 | 13.3 | 19.2 | 71 |
| STEEL WIRE 1 | WIRE ROD 1 | | | | | |
| COMPARATIVE EXAMPLE | COMPARATIVE EXAMPLE | 30 | 1.3 | 15.4 | 10.5 | 72 |
| STEEL WIRE 2 | WIRE ROD 2 | | | | | |
| COMPARATIVE EXAMPLE | COMPARATIVE EXAMPLE | 30 | 1.5 | 13.3 | 17.5 | 70 |
| STEEL WIRE 3 | WIRE ROD 3 | | | | | |
| COMPARATIVE EXAMPLE | COMPARATIVE EXAMPLE | 30 | 1.4 | 14.3 | 16.4 | 71 |
| STEEL WIRE 4 | WIRE ROD 4 | | | | | |
| COMPARATIVE EXAMPLE | COMPARATIVE EXAMPLE | 30 | 1.3 | 15.4 | 18.8 | 69 |
| STEEL WIRE 5 | WIRE ROD 5 | | | | | |
| COMPARATIVE EXAMPLE | COMPARATIVE EXAMPLE | 30 | 1.2 | 16.7 | 20.1 | 66 |
| STEEL WIRE 6 | WIRE ROD 6 | | | | | |
| COMPARATIVE EXAMPLE | EXAMPLE WIRE ROD 2 | 5 | 1.0 | 20.0 | 10.7 | 70 |
| STEEL WIRE 7 | | | | | | |
| COMPARATIVE EXAMPLE | EXAMPLE WIRE ROD 5 | 70 | 2.4 | 8.3 | 5.9 | 67 |
| STEEL WIRE 8 | | | | | | |
| COMPARATIVE EXAMPLE | COMPARATIVE EXAMPLE | 30 | 1.5 | 13.3 | 13.1 | 58 |
| STEEL WIRE 9 | WIRE ROD 7 | | | | | |
| COMPARATIVE EXAMPLE | COMPARATIVE EXAMPLE | 30 | 1.5 | 13.3 | 12.1 | 52 |
| STEEL WIRE 10 | WIRE ROD 8 | | | | | |

AN UNDERLINED VALUE WAS OUT OF THE RANGE OF THE PRESENT INVENTION

TABLE 4

| | | | | | AVERAGE | | | |
|---|---|---|---|---|---|---|---|---|
| | | | AVERAGE | | BLOCK | | | |
| | | | ASPECT | | SIZE AT | | | |
| | | KEEPING | RATIO OF | | SURFACE | | | |
| | | TEMPER- | PEARLITE | | PART OF | | | |
| | | ATURE | BLOCK AT | | SHAFT | | | HYDROGEN |
| | | AFTER | SURFACE | | PART OF | TENSILE | PROOF | EMBRIT- |
| | | WORKING | PART OF | 20/AR | BOLT | STRENGTH | STRESS | TLEMENT |
| | STEEL WIRE | (° C.) | SHAFT | (μm) | (μm) | (MPa) | RATIO | RESISTANCE |
| EXAMPLE BOLT 1 | EXAMPLE STEEL WIRE 1 | 300 | 1.3 | 15.4 | 8.8 | 1124 | 0.95 | GOOD |
| EXAMPLE BOLT 2 | EXAMPLE STEEL WIRE 2 | 300 | 1.4 | 14.3 | 7.6 | 1136 | 0.96 | GOOD |
| EXAMPLE BOLT 3 | EXAMPLE STEEL WIRE 3 | 300 | 1.3 | 15.4 | 9.3 | 1247 | 0.95 | GOOD |
| EXAMPLE BOLT 4 | EXAMPLE STEEL WIRE 4 | 300 | 1.3 | 15.4 | 10.4 | 1266 | 0.94 | GOOD |
| EXAMPLE BOLT 5 | EXAMPLE STEEL WIRE 5 | 300 | 1.3 | 15.4 | 10.2 | 1320 | 0.94 | GOOD |
| EXAMPLE BOLT 6 | EXAMPLE STEEL WIRE 6 | 300 | 1.4 | 14.3 | 12.2 | 1433 | 0.95 | GOOD |
| EXAMPLE BOLT 7 | EXAMPLE STEEL WIRE 7 | 300 | 1.4 | 14.3 | 11.6 | 1526 | 0.93 | GOOD |
| COMPARATIVE | COMPARATIVE EXAMPLE | 300 | 1.4 | 14.3 | 19.3 | 1144 | 0.95 | BAD |
| EXAMPLE BOLT 1 | STEEL WIRE 1 | | | | | | | |
| COMPARATIVE | COMPARATIVE EXAMPLE | 300 | 1.3 | 15.4 | 10.6 | *1 | | |
| EXAMPLE BOLT 2 | STEEL WIRE 2 | | | | | | | |
| COMPARATIVE | COMPARATIVE EXAMPLE | 300 | 1.5 | 13.3 | 17.7 | 1274 | 0.93 | BAD |
| EXAMPLE BOLT 3 | STEEL WIRE 3 | | | | | | | |
| COMPARATIVE | COMPARATIVE EXAMPLE | 300 | 1.4 | 14.3 | 16.4 | 1189 | 0.94 | BAD |
| EXAMPLE BOLT 4 | STEEL WIRE 4 | | | | | | | |
| COMPARATIVE | COMPARATIVE EXAMPLE | 300 | 1.3 | 15.4 | 18.8 | 1294 | 0.95 | BAD |
| EXAMPLE BOLT 5 | STEEL WIRE 5 | | | | | | | |
| COMPARATIVE | COMPARATIVE EXAMPLE | 300 | 1.2 | 16.7 | 20.3 | 1426 | 0.93 | BAD |
| EXAMPLE BOLT 6 | STEEL WIRE 6 | | | | | | | |
| COMPARATIVE | COMPARATIVE EXAMPLE | 300 | 1.0 | 20.0 | 10.6 | 820 | 0.93 | GOOD |
| EXAMPLE BOLT 7 | STEEL WIRE 7 | | | | | | | |
| COMPARATIVE | COMPARATIVE EXAMPLE | 300 | 2.4 | 8.3 | 5.9 | *1 | | |
| EXAMPLE BOLT 8 | STEEL WIRE 8 | | | | | | | |
| COMPARATIVE | EXAMPLE STEEL WIRE 1 | NON- | 1.2 | 16.7 | 8.7 | 1080 | 0.88 | GOOD |
| EXAMPLE BOLT 9 | | HEATED | | | | | | |
| COMPARATIVE | EXAMPLE STEEL WIRE 4 | 450 | 1.1 | 18.2 | 10.5 | 1140 | 0.94 | BAD |
| EXAMPLE BOLT 10 | | | | | | | | |

| | | | | | | |
|---|---|---|---|---|---|---|
| COMPARATIVE | COMPARATIVE EXAMPLE | 300 | 1.5 | 13.3 | 13.0 | *1 |
| EXAMPLE BOLT 11 | STEEL WIRE 9 | | | | | |
| COMPARATIVE | COMPARATIVE EXAMPLE | 300 | 1.5 | 13.3 | 12.2 | *1 |
| EXAMPLE BOLT 12 | STEEL WIRE 10 | | | | | |

AN UNDERLINED VALUE WAS OUT OF THE RANGE OF THE PRESENT INVENTION
*1 BOLT COULD NOT BE FORMED DUE TO BAD WORKABILITY

1. A wire rod having a tensile strength of 950 to 1600 MPa for manufacturing a steel wire for a pearlite structure bolt, wherein
a chemical composition thereof comprises, in terms of mass %:
C: 0.35 to 0.65%;
Si: 0.15 to 0.35%;
Mn: 0.30 to 0.90%;
P: 0.020% or less;
S: 0.020% or less;
Al: 0.010 to 0.050%;
N: 0.0060% or less;
O: 0.0030% or less;
one or both selected from the group consisting of As and Sb: 0.0005 to 0.0100% in total;
Cr: 0 to 0.20%;
Cu: 0 to 0.05%;
Ni: 0 to 0.05%;
Ti: 0 to 0.02%;
Mo: 0 to 0.10%;
V: 0 to 0.10%;
Nb: 0 to 0.02%; and
a remainder including Fe and impurities,
the wire rod is manufactured by hot rolling and then direct isothermal transformation treating,
when an amount of C in terms of mass % is indicated as <C>, a structure at an area from a surface of the wire rod to a depth of 4.5 mm includes 140×<C> area % or more of a pearlite structure,
an average block size of a pearlite block at the area from the surface of the wire rod to the depth of 4.5 mm is 20 μm or less, in which the average block size is measured in a transverse section of the wire rod, and
an average lamellar spacing of the pearlite structure at the area from the surface of the wire rod to the depth of 4.5 mm is more than 120 nm to 200 nm.

2. The wire rod having tensile strength of 950 to 1600 MPa for manufacturing the steel wire for the pearlite structure bolt according to claim 1, wherein
the chemical composition includes one or more selected from the group consisting of, in terms of mass %;
Cr: 0.005 to 0.20%;
Cu: 0.005 to 0.05%;
Ni: 0.005 to 0.05%;
Ti: 0.001 to 0.02%;
Mo: 0.005 to 0.10%;
V: 0.005 to 0.10%; and
Nb: 0.002 to 0.02%.

3. A steel wire having tensile strength of 950 to 1600 MPa for a pearlite structure bolt, wherein
the steel wire is manufactured from the wire rod having a tensile strength of 950 to 1600 MPa for manufacturing the steel wire for the pearlite structure bolt according to claim 1,
a structure at an area from a surface of the steel wire to a depth of 2.0 mm includes 140×<C> area % or more of the pearlite structure which is wire drawn,
an average aspect ratio AR of the pearlite block at the area from the surface of the steel wire to the depth of 2.0 mm is 1.2 to less than 2.0 in which the aspect ratio AR is measured in a longitudinal section of the steel wire, and
the average block size of the pearlite block at the area from the surface of the steel wire to the depth of 2.0 mm is 20/AR μm or less in which the average block size is measured in a transverse section of the steel wire.

4. A pearlite structure bolt, wherein
the pearlite structure bolt is manufactured from the steel wire having tensile strength of 950 to 1600 MPa for a pearlite structure bolt according to claim 3,
a structure at an area from a surface of a shaft part of the pearlite structure bolt to a depth of 2.0 mm includes 140×<C> area % or more of the pearlite structure which is wire drawn,
the average aspect ratio AR of the pearlite block at the area from the surface of the shaft part of the pearlite structure bolt to the depth of 2.0 mm is 1.2 to less than 2.0 in which the aspect ratio AR is measured in a longitudinal section of the pearlite structure bolt,
the average block size of the pearlite block at the area from the surface of the shaft part of the pearlite structure bolt to the depth of 2.0 mm is 20/AR μm or less in which the average block size is measured in a transverse section of the pearlite structure bolt, and
tensile strength is 950 to 1600 MPa.

5. The pearlite structure bolt according to claim 4, wherein
the pearlite structure bolt is a flange bolt.

6. A method for manufacturing a wire rod having a tensile strength of 950 to 1600 MPa for manufacturing a steel wire for a pearlite structure bolt, wherein
the method comprises:
heating a steel piece to 1000 to 1150° C., in which a chemical composition of the steel piece includes, in terms of mass %, C: 0.35 to 0.65%; Si: 0.15 to 0.35%; Mn: 0.30 to 0.90%; P: 0.020% or less; S: 0.020% or less; Al: 0.010 to 0.050%; N: 0.0060% or less; O: 0.0030% or less; one or both selected from the group consisting of As and Sb: 0.0005 to 0.0100% in total; Cr: 0 to 0.20%; Cu: 0 to 0.05%; Ni: 0 to 0.05%; Ti: 0 to 0.02%; Mo: 0 to 0.10%; V: 0 to 0.10%; Nb: 0 to 0.02%; and a remainder including Fe and impurities,
hot rolling the slab to obtain a wire rod with a finish rolling temperature of 800 to 950° C.,
isothermal transformation treating by directly immersing the wire rod having temperature of 800 to 950° C. into a molten salt bath having temperature of 450 to 600° C. during 50 seconds or more, and
water cooling the wire rod from 400° C. or higher to 300° C. or lower.

7. The method for manufacturing the wire rod having tensile strength of 950 to 1600 MPa for manufacturing the steel wire for the pearlite structure bolt according to claim 6, wherein
the chemical composition of the steel piece includes one or more selected from the group consisting of, in terms of mass %, Cr: 0.005 to 0.20%; Cu: 0.005 to 0.05%; Ni: 0.005 to 0.05%; Ti: 0.001 to 0.02%; Mo: 0.005 to 0.10%; V: 0.005 to 0.10%; and Nb: 0.002 to 0.02%.

8. A method for manufacturing a steel wire having tensile strength of 950 to 1600 MPa for a pearlite structure bolt, wherein
the method comprises:
wire drawing the wire rod having tensile strength of 950 to 1600 MPa for manufacturing the steel wire for the pearlite structure bolt according to claim 1 at a room temperature in which a total reduction of area is 10 to 55%.

9. A method for manufacturing a pearlite structure bolt, wherein
the method comprises:
working the steel wire having tensile strength of 950 to 1600 MPa for the pearlite structure bolt according to claim 3 so as to be a bolt shape by cold forging or by the cold forging and form rolling to obtain a bolt; and
keeping the bolt within a temperature range of 100 to 400° C. during 10 to 120 minutes.

10. The method for manufacturing a pearlite structure bolt according to claim 9, wherein
the bolt shape is a flange bolt shape.

11. A steel wire having tensile strength of 950 to 1600 MPa for a pearlite structure bolt, wherein
the steel wire is manufactured from the wire rod having a tensile strength of 950 to 1600 MPa for manufacturing the steel wire for the pearlite structure bolt according to claim 2, a structure at an area from a surface of the steel wire to a depth of 2.0 mm includes 140×<C> area % or more of the pearlite structure which is wire drawn,
an average aspect ratio AR of the pearlite block at the area from the surface of the steel wire to the depth of 2.0 mm is 1.2 to less than 2.0 in which the aspect ratio AR is measured in a longitudinal section of the steel wire, and
the average block size of the pearlite block at the area from the surface of the steel wire to the depth of 2.0 mm is 20/AR μm or less in which the average block size is measured in a transverse section of the steel wire.

12. A pearlite structure bolt, wherein
the pearlite structure bolt is manufactured from the steel wire having tensile strength of 950 to 1600 MPa for a pearlite structure bolt according to claim 11,
a structure at an area from a surface of a shaft part of the pearlite structure bolt to a depth of 2.0 mm includes 140×<C> area % or more of the pearlite structure which is wire drawn,
the average aspect ratio AR of the pearlite block at the area from the surface of the shaft part of the pearlite structure bolt to the depth of 2.0 mm is 1.2 to less than 2.0 in which the aspect ratio AR is measured in a longitudinal section of the pearlite structure bolt,
the average block size of the pearlite block at the area from the surface of the shaft part of the pearlite structure bolt to the depth of 2.0 mm is 20/AR μm or less in which the average block size is measured in a transverse section of the pearlite structure bolt, and
tensile strength is 950 to 1600 MPa.

13. The pearlite structure bolt according to claim 12, wherein
the pearlite structure bolt is a flange bolt.

14. A method for manufacturing a steel wire having tensile strength of 950 to 1600 MPa for a pearlite structure bolt, wherein
the method comprises:
wire drawing the wire rod having tensile strength of 950 to 1600 MPa for manufacturing the steel wire for the pearlite structure bolt according to claim 2 at a room temperature in which a total reduction of area is 10 to 55%.

15. A method for manufacturing a pearlite structure bolt, wherein
the method comprises:
working the steel wire having tensile strength of 950 to 1600 MPa for the pearlite structure bolt according to claim 11 so as to be a bolt shape by cold forging or by the cold forging and form rolling to obtain a bolt; and
keeping the bolt within a temperature range of 100 to 400° C. during 10 to 120 minutes.

16. The method for manufacturing a pearlite structure bolt according to claim 15, wherein
the bolt shape is a flange bolt shape.
